(19) United States
(12) Patent Application Publication
(10) Pub. No.: US 2006/0011711 A1
(43) Pub. Date: Jan. 19, 2006

(54) Method of fabricating a semiconductor device and mounting equipment

(76) Inventor: Toshikazu Mino, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/179,545

(22) Filed: Jul. 13, 2005

(30) Foreign Application Priority Data
Jul. 13, 2004 (JP) 2004-205427

(51) Int. Cl. B23K 31/02

(52) U.S. Cl. 228/180.22

(57) ABSTRACT

According to an aspect of the invention, there is provided a method of fabricating a semiconductor device including, heating a semiconductor component including a first solder bump, pressing the first solder bump onto a stage having asperity, coating a flux on the first solder bump, heating a substrate including a second solder bump, pressing the second solder bump onto the stage having asperity, coating the flux on the second solder bump, contacting the first solder bump on the second solder bump by disposing the semiconductor component on the substrate, and coupling the first solder bump and the second solder bump by heating the semiconductor component and the substrate.

### CROSS REFERENCE TO RELATED APPLICATION

This application is based upon and claims the benefit of priority from the prior Japanese Patent Application No. 2004-205427, filed Jul. 13, 2004, the entire contents of which are incorporated herein by reference.

### FIELD OF THE INVENTION

The present invention relates to a method of fabricating a semiconductor device and a mounting equipment, and in particular, relates to a mounting method and a mounting equipment to mount a semiconductor component including a solder bump on a substrate.

### DESCRIPTION OF THE BACKGROUND

In conventional technique of mounting a semiconductor component including a solder bump, such as a flip chip, on a substrate, an oxidized film formed on a lower end portion of the solder bump is removed so as to form a newly exposed surface while a height of lower surface of the solder bump is uniformed by flattening technique. The semiconductor component is electrically connected to the newly exposed surface on the substrate.

Japanese Patent Publication (Kokai) No. 2003-23036 discloses a mounting method with connecting the semiconductor component including the solder bump to the substrate. FIGS. 5A-5F are cross-sectional views showing a conventional method of mounting a semiconductor component including a solder bump on a substrate in order steps.

As shown in FIG. 5A, a semiconductor component 103 including a solder bump 103a is picked up from a tray 102 by a transfer head 101.

As shown in FIG. 5B, the transfer head 101 retaining the semiconductor component 103 including the solder bump 103a is moved above a flux supply portion 104, subsequently the transfer head 101 is descending so as to descend the semiconductor component 103 including the solder bump 103a to a flat plane 105a of the flux supply portion 104. A coated flux film 106a having a prescribed film thickness is formed on the surface of the flat plane 105a.

As shown in FIG. 5C, the solder bump 103a of the semiconductor component 103 contacts with the surface of the flat plane 105a. The transfer head 101 presses the semiconductor component 103 including the solder bump 103a to the flat plane 105a by a prescribed pressing weight while horizontally reciprocating with a prescribed amplitude so as to polish a lower end portion of the solder bump 103a by sliding on the flat plane 105a.

As shown in FIG. 5D, the transfer head 101 is again ascended from the flux supply portion 104 so that a flux 106 is coated on a lower end portion of the solder bump 103a by transfer technique. In the process steps mentioned above, the oxidized film at the surface of the lower end portion of the solder bump 103a is removed by polishing so that a newly exposed surface is formed on the solder alloy. The flux 106 prevents a newly exposed surface from oxidation.

As shown in FIG. 5E, the transfer head 101 is moved again above a substrate support portion 107. The solder bump 103a is positioned to an electrode 108a formed on a substrate 108. Descending the transfer head 101 provides to dispose the semiconductor component 103 including the solder bump 103a on the substrate 108.

As shown in FIG. 5F, the substrate 108 on which disposed the semiconductor component 103 including the solder bump 103a is transferred to reflow process steps. The solder bump 103a is heating in the reflow process steps so as to be melt and to be connected with the electrode 108a.

In the mounting method of the semiconductor component including the solder bump mentioned above, polished surface of the solder bump is flattened, as a result, forming the newly exposed surface cannot provide a sufficient area of the surface.

Therefore, a mounting method of a semiconductor component including a many solder bumps, each of which has narrow interval for the adjusting bumps, may not provide sufficiently reliable connections.

### SUMMARY OF THE INVENTION

According to an aspect of the invention, there is provided a method of fabricating a semiconductor device including, heating a semiconductor component including a first solder bump, pressing the first solder bump onto a stage having asperity, coating a flux on the first solder bump, heating a substrate including a second solder bump, pressing the second solder bump on the stage having asperity, coating the flux on the second solder bump, contacting the first solder bump on the second solder bump by disposing the semiconductor component on the substrate, and coupling the first solder bump and the second solder bump by heating the semiconductor component and the substrate.

According to another aspect of the invention, there is provided a method of fabricating a semiconductor device including, heating a semiconductor component including a first solder bump, pressing the first the solder bump onto a stage having asperity, coating a flux on the first solder bump, heating a substrate including a second solder bump, pressing the second solder bump on the stage having asperity, coating a resin on the second solder bump, contacting the first solder bump on the second solder bump by disposing the semiconductor component on the substrate, and coupling the first solder bump and the second solder bump by heating the semiconductor component and the substrate.

According to another aspect of the invention, there is provided mounting equipment mounting a semiconductor component including a first solder bump on a substrate including a second solder bump including, a base, a semiconductor component supply portion disposed on the base, the semiconductor component supply portion supplying a semiconductor component and a substrate, a bump pressing portion disposed on the base, the bump pressing portion including a transfer head and a first stage, the bump pressing portion descending the transfer head, the transfer head including a vacuum chuck and a heater, the transfer head retaining the semiconductor component and the substrate, the transfer head moving above the base, the transfer head descending at prescribed portions, the vacuum chuck picking up the semiconductor component and the substrate from the semiconductor component supply portion, the vacuum chuck retaining the semiconductor component and the substrate, the heater heating the semiconductor component and the substrate, the first stage arranged in opposed to the transfer head, the first stage having asperity, the first stage including a vacuum chuck and a heater, the vacuum chuck retaining the substrate, the heater heating the substrate, the bump pressing portion pressing the semiconductor component and the substrate onto the first stage so as to form a newly exposed surface on the first solder bump and the second solder bump, respectively, and a semiconductor component disposing portion disposed on the base, the semiconductor component including the second stage, the second stage being disposed the substrate on, wherein the second solder bump on the substrate contact with the first solder bump on the semiconductor component retained by the transfer head.

### BRIEF DESCRIPTION OF THE DRAWINGS

FIG. 1 is a block diagram showing a mounting equipment fabricating a semiconductor component having a solder bump according to a first embodiment of a present invention;

FIG. 2 is a cross-sectional view showing a bump pressing portion in the mounting equipment according to the first embodiment of the present invention;

FIGS. 3A-3I are cross-sectional views showing a method of mounting the semiconductor component having a solder bump according to the first embodiment of the present invention;

FIGS. 4A-4B are cross-sectional views showing a method of mounting a semiconductor component having a solder bump according to a second embodiment of the present invention;

FIGS. 5A-5F are cross-sectional views showing a method of mounting a semiconductor component having a solder bump according to a conventional method.

### DETAILED DESCRIPTION OF THE INVENTION

Embodiments of the present invention will be described hereinafter in detail with reference to the drawings mentioned above.

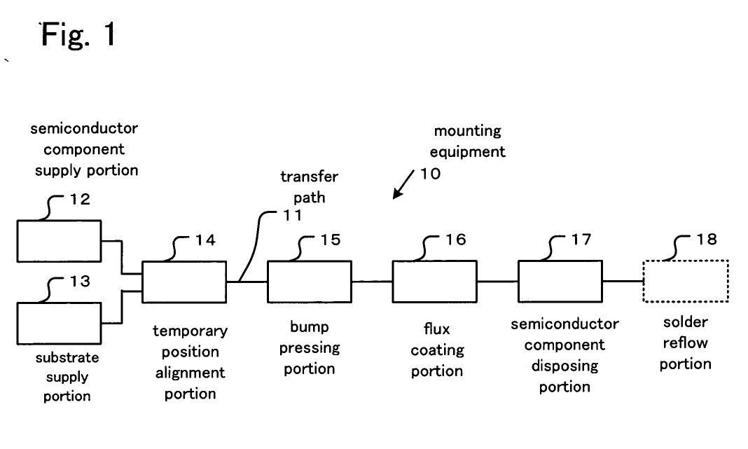

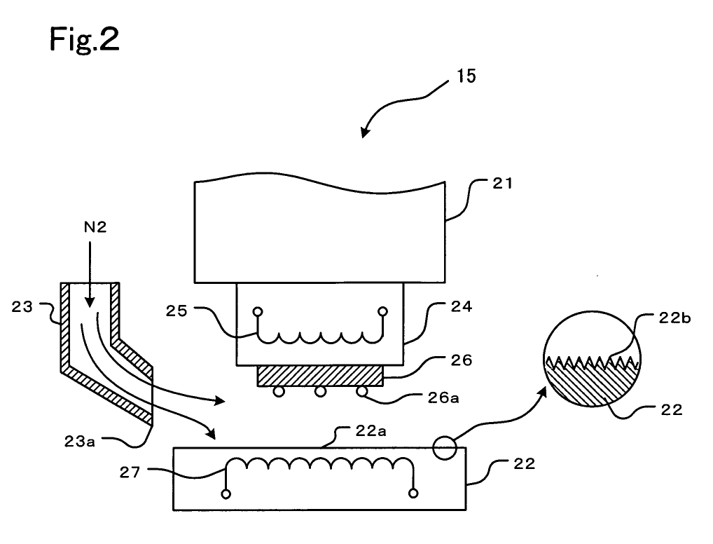

First, according to a first embodiment of the present invention, a mounting equipment for mounting a semiconductor component on a substrate and a method of fabricating a semiconductor device are explained with reference to FIGS. 1-2. FIG. 1 is a block diagram showing a mounting equipment for mounting the semiconductor component on a substrate according to a first embodiment of the present invention. FIG. 2 is a cross-sectional view showing a bump pressing portion in the mounting equipment.

As shown in FIG. 1, a mounting equipment 10 includes a transfer path 11 disposed on a base (not illustrated) along a main direction of the base. A semiconductor component supply portion 12 and a substrate supply portion 13 are arranged in one side opposed to the transfer path 11. A temporary position alignment portion 14, a bump pressing portion 15, a flux coating portion 16 and a semiconductor component disposing portion 17 are arranged in the other side having the transfer path 11.

The semiconductor component supply portion 12 supplies a semiconductor component having a solder bump, such as a CPU chip or a memory chip, housed in a magazine to the temporary position alignment portion 14 by using a loader. The substrate supply portion 13 also supplies a substrate having the solder bump, such as a ceramic package, housed in the magazine to the temporary position alignment portion 14 by the loader.

In the temporary position alignment portion 14, a direction of the semiconductor component and the substrate are aligned and the semiconductor component and the substrate are transferred into a tray. The semiconductor component and the substrate are removed from the try by a transfer head (not illustrated) and are transferred along the transfer path 11 while being retained by the transfer head.

The semiconductor component and the substrate retained by the transfer head is heated in the bump pressing portion 15. The solder bump is pressed onto a stage with an asperity in the bump pressing portion 15 so as to crush the end portion of the solder bump and to form a newly exposed surface. In the flux coating portion 16, the solder bump of the semiconductor component and the substrate retained by the transfer head is contacted on the stage coated with a thin flux so as to transfer the flux on the newly exposed surface of the solder bump.

The solder bump of the semiconductor component is disposed on the solder bump of the substrate in the semiconductor component disposing portion 17 and subsequently the semiconductor component is disposed on the substrate so as to tentatively fasten between the semiconductor component and the substrate. The semiconductor component and the substrate are transferred to a solder reflow portion 18 in a reflow equipment which is a different from the mounting equipment 10.

As shown in FIG. 2, the bump pressing portion 15 includes a transfer head 21, a first stage 22 with asperity at an upper surface and a gas nozzle 23.

The transfer head 21 has a function of horizontal and vertical movement with respect to the transfer path 11. The transfer head 21 includes a vacuum chuck 24 having a heater 25. A semiconductor component 26 is retained by the vacuum chuck 24 and heated by the heater 25 at a prescribed temperature that the solder bump 26a does not melt.

The first stage 22 includes a heater 27, and an upper surface of the first stage 22a is mechanically processed to have asperity, such as protrusions 22b. The solder bump 26a of the semiconductor component 26 is absorbed to the upper surface of the first stage 22a retained by the vacuum chuck 24 and is pressed by the transfer head 21. The upper surface of the first stage 22a is heated by the heater 27 at a prescribed temperature that the solder bump 26a does not melt.

A performance of the heater 25, 27 involve not to make the solder bump melt 26a in rising temperature. In this case, the heater 25, 27 may not be restricted, however, a thin film heater embedded in the vacuum chuck 24 is desirable.

One end of the gas nozzle 23 is coupled to an inactive gas source, such as a nitrogen gas supply line (not illustrated), the other end of the gas nozzle 23 is arranged near the first stage 22. Blowing an inactive gas from a gas ejection portion 23a to the upper surface of the first stage 22a results in controlling of atmosphere near the upper surface of the first stage 22a as a non-oxidizing gas.

A method of mounting the semiconductor component on the substrate by the mounting equipment 10 is explained in detail.

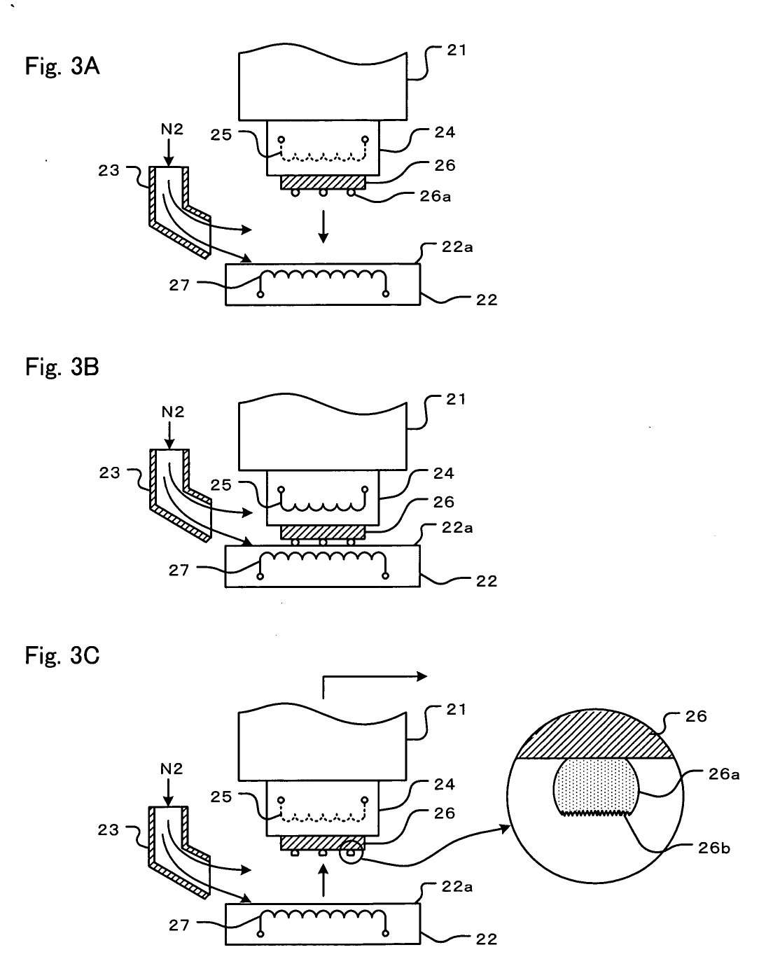

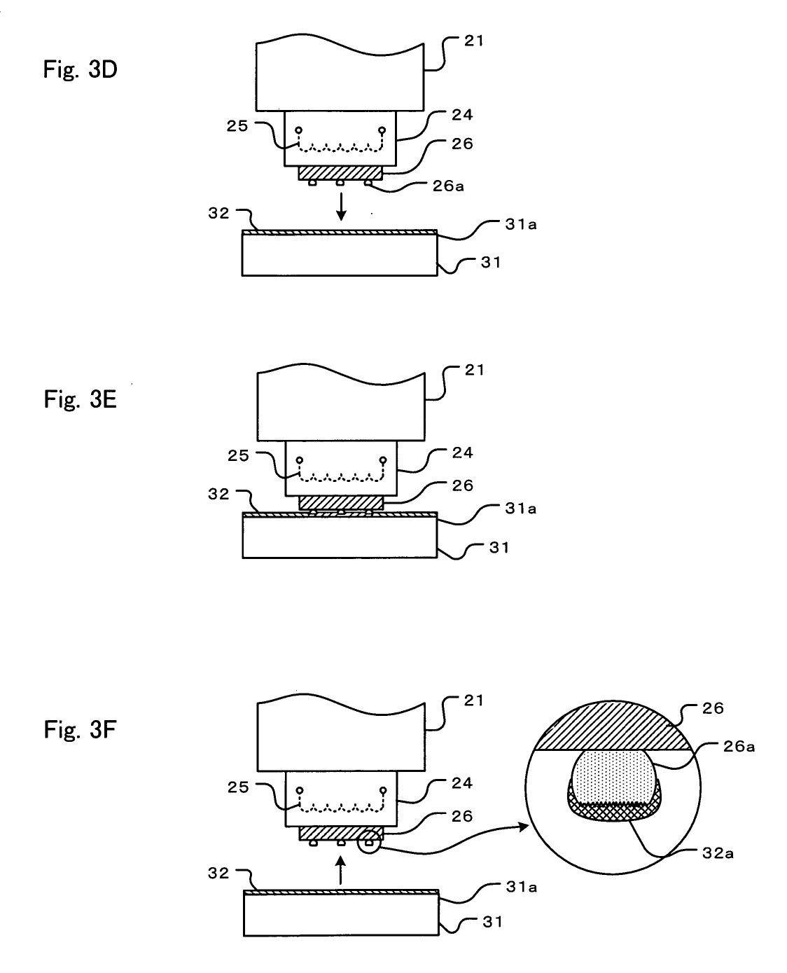

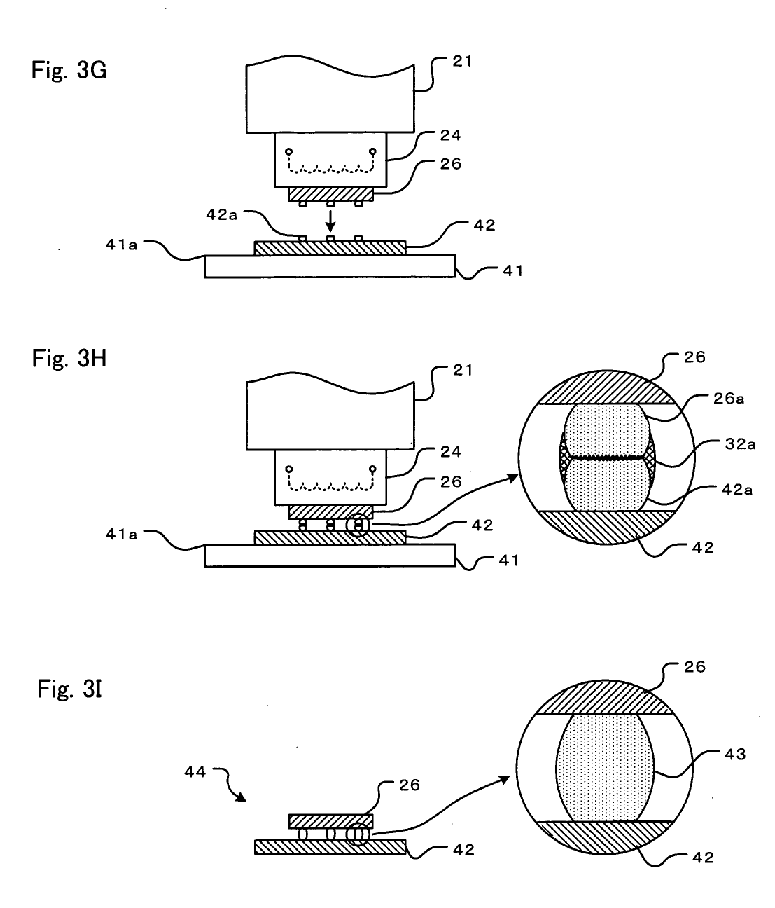

FIGS. 3A-3I are cross-sectional views showing process steps of mounting the semiconductor component on the substrate in order to steps. FIGS. 3A-3C are cross-sectional views showing a pressing process of the solder bump. FIGS. 3D-3F are cross-sectional views showing a coating process of a flux on the solder bump. FIGS. 3G-3I are cross-sectional views showing a disposing process of the semiconductor component on the substrate and a coupling process of the solder bump.

As shown in FIG. 3A, the solder bump 26a of the semiconductor component 26 is retained by the vacuum chuck 24 where the surface of the semiconductor component 26 is faced to downward and is transferred from a tray (not illustrated) of the temporary position alignment portion 14 to an upper portion of the first stage 22.

The heater 27 preliminarily rises a temperature of the upper surface of the first stage 22a below melting point of the solder bump 26a, such as 100˜270° C. Nitrogen gas blew from the gas nozzle 23 retains the upper surface of the first stage 22a and near there as non-oxidizing atmosphere. In this stage, the heater 25 is put off.

As shown in FIG. 3B, after the heater 25 is put on, descending the transfer head 21 retaining the semiconductor component 26 conducts the semiconductor component 26 having the solder bump 26a onto the upper surface of the first stage 22a. Subsequently, the transfer head 21 presses the semiconductor component 26 having the solder bump 26a on the upper surface of the first stage 22a at a prescribed pressing-load.

A solder alloy is softened by heating, subsequently the protrusions 22b burst through an oxide skin film (not illustrated) and cover the surface of the solder alloy by using pressing. The solder bump 26a is stuck by the protrusions 22b and a lower end portion of the solder bump 26a crushed by pressing so as to be deformed. Accordingly, a newly exposed surface area can be sufficiently formed by lower pressing strength.

A diameter of the protrusions 22b can be such as 10%-20% of that of the solder bump. For example, when the solder bump has a diameter of 100 μm, it is suitable that the protrusions 22b have a height of 10 μm and a length of 10 μm. The substrate 22 having the protrusions 22b enable to form a newly exposed surface having about 100 protrusions in the lower portion of the solder bump so as to have twice area as compared with a plane surface.

As shown in FIG. 3C, after the heater 25 is put off, the transfer head 21 retaining the semiconductor component 26 is again raised up. The semiconductor component 26 is retained in non-oxidizing atmosphere until a temperature of the semiconductor component 26 is rapidly decreased to a range which the solder bump 26a is not oxidized in the atmosphere.

Accordingly, the solder bump 26a having the same protrusions 26b in shape as the protrusions 22a and sufficiently having newly exposed surface area is obtained.

As shown in FIG. 3D, the transfer head 21 retaining the semiconductor component 26 is moved over a second stage 31 of the flux coating portion 16, subsequently the transfer head 21 is descended. The semiconductor component 26 having the solder bump 26a is descended on the upper surface of the second stage 31a. The coated flux film 32 with a prescribed film-thickness is formed on the upper surface of the second stage 31a.

As shown in FIG. 3E, the solder bump 26a of the semiconductor component 26 contacts with the upper surface of the second stage 31a and the solder bump 26a is immersed in the flux film 32.

As shown in FIG. 3F, the transfer head 21 is again ascended from the second stage 31. The flux film 32 is coated on the lower end portion of the solder bump 26a by transferring technique. As a result, a newly exposed surface formed in the under surface of solder bump 26a is protected by a surface film 32a of the flux film 32 and is prevented from oxidizing.

A newly exposed surface is formed on the solder bump and the flux is coated on the substrate. The processing steps are basically the same as those in the above-mentioned steps and the explanations on the processing steps are omitted.

As shown in FIG. 3G, the transfer head 21 retaining the semiconductor component 26 is moved above a third stage 41 of a semiconductor component disposing portion 17. The transfer head 21 is descended onto an upper surface of the third stage 41a. The substrate 42 including the solder bump 42a and being formed the newly exposed surface is arranged on the third stage 41a.

As shown in FIG. 3H, the solder bump 26a of the semiconductor component 26 is positioned to the solder bump 42a of the substrate 42. The solder bump 26a of the semiconductor component 26 is disposed on the solder bump 42a of the substrate 42 and the semiconductor component 26 is disposed on the substrate 42 by descending the transfer head 21.

As shown in FIG. 3I, the substrate 42 including the solder bump 42a disposed on the semiconductor component 26 including the solder bump 26a is transferred to the reflow portion 18. Heating the substrate 42 in the reflow portion 18 causes melting and mixing the solder bump 26a, 42a so as to be formed the solder bump coupling portion 43. Finally, the semiconductor device 44 is completed. The semiconductor device 44 has the semiconductor component 26 including the solder bump mounted on the substrate 42 including the solder bump 42a.

As mentioned above, the solder alloy is softened by heating in the method of mounting the semiconductor component, and subsequently the solder bump is pressed on a stage having asperity to be deforming. Accordingly, a newly exposed surface having a sufficient area can be formed in the solder bump by lower pressing strength.

Coupling between the semiconductor component and the substrate at the newly exposed surface provides a high reliable performance on the coupling area. Accordingly, a highly reliable semiconductor device having high packing density can be provided.

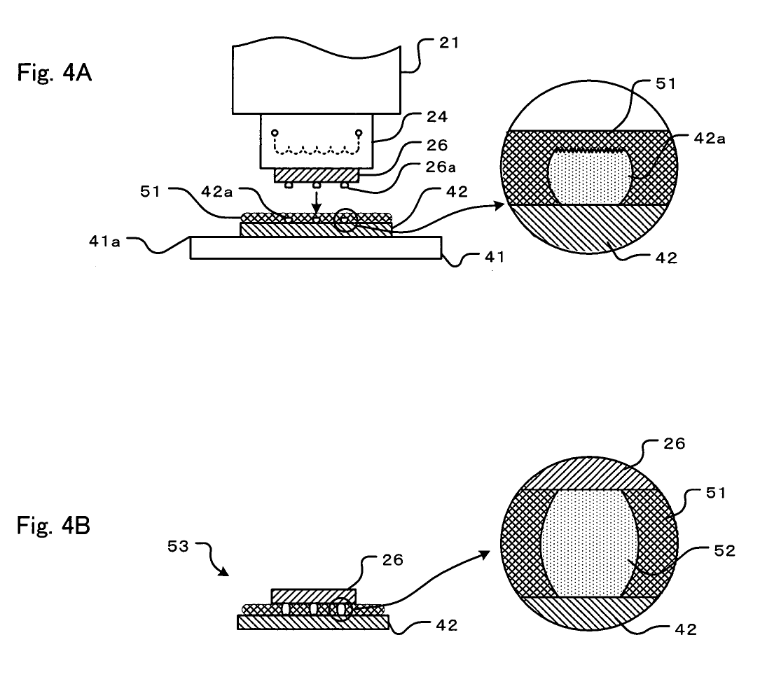

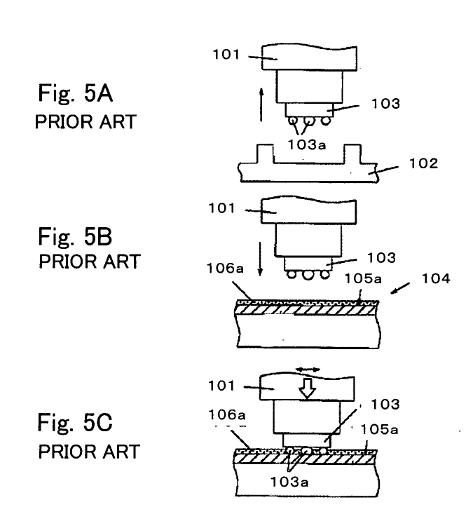

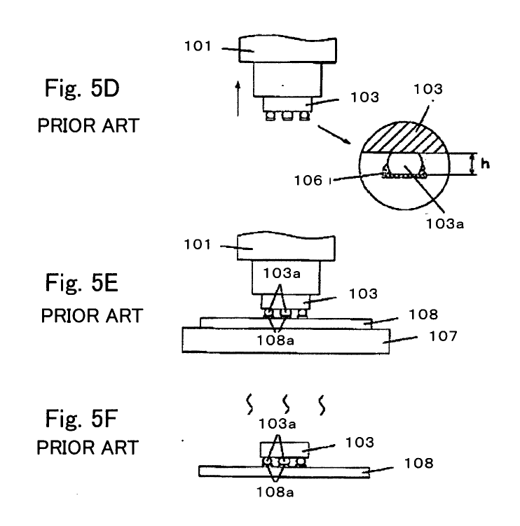

Next, according to a second embodiment of the present invention, a mounting process is explained with reference to FIG. 4.

FIG. 4 is a cross-sectional view showing a method of mounting of a semiconductor component called no-flow-under-fill method in order of steps by using a mounting equipment. The no-flow-under-fill method conducts simultaneously coupling between solder bumps and sealing over the coupling portion with a resin to airproof the coupling portion.

In the second embodiment, a portion of a same composition as the first embodiment is attached the same number and explanation of the portion of the same composition is omitted.

The second embodiment has a different point from the first embodiment as mentioned below. A resin is coated on a substrate so as to bury the solder bump 42a; the semiconductor component 26 is successively disposed on the substrate.

As shown in FIG. 4A, the substrate 42 formed a newly exposed surface having a sufficient area is disposed on the upper surface of a third stage 41a. A resin 51 being a thickness of such as 100˜150 μm is coated on the solder bump 42a.

The solder bump 26a of the semiconductor component 26 is positioned to the solder bump 42a of the substrate 42, and subsequently is disposed on the solder bump 42a of the substrate 42 and the semiconductor component 26 is disposed on the substrate 42 by descending the transfer head 21.

The resin 51 may have heat resistance against melting point of the solder and adhesiveness with the solder, therefore a silicon resin is suitable, for example. Furthermore, the resin 51 is coated on the substrate 42 by a dispenser (not illustrated).

As shown in FIG. 4B, the substrate 42 disposed on the semiconductor component 26 is transferred to a reflow portion 18 (not illustrated). Heating the substrate 42 in the reflow portion 18 causes melting and mixing the solder bump 26a, 42a so as to be formed a solder bump coupling portion 52. Finally, a semiconductor device 53 is completed. The semiconductor device 44 has the semiconductor component 26 including the solder bump mounted on the substrate 42 including the solder bump 42a.

As mentioned above, coupling between the solder bumps without a flux and filling a resin into a space between a semiconductor component and a substrate are simultaneously performed by the no-flow-under-fill method. As a newly exposed surface with a sufficient area is formed, coupling between the semiconductor component and the substrate at the newly exposed surface provides a high reliable performance on the coupling area.

In the method of mounting the semiconductor component according to the second embodiment, the no-flow-under-fill method without the flux can provide a high reliable performance on the coupling area, as the newly exposed surface with a sufficient area is formed.

In this way, semiconductor device having a high reliable coupling can be obtained by relatively less process steps.

Accordingly, a highly reliable semiconductor device having high packing density can be provided.

Other embodiments of the present invention will be apparent to those skilled in the art from consideration of the specification and practice of the invention disclosed herein. It is intended that the specification and example embodiments be considered as exemplary only, with a true scope and spirit of the invention being indicated by the claims that follow. The invention can be carried out by being variously modified within a range not deviated from the gist of the invention.

For example, a newly exposed surface may be formed on a semiconductor component or a solder bump in a range of specific coupling strength.

Moreover, a sheet having protrusions may be disposed on an upper surface of a first stage. Melting and mixing solder bump of a semiconductor component and a solder bump of a substrate by heating may start simultaneously with disposing the semiconductor component on the substrate. Moreover, atmosphere in a heating process may be reductive.

What is claimed is:

1. A method of fabricating a semiconductor device, comprising:
heating a semiconductor component including a first solder bump;
pressing the first solder bump onto a stage having asperity;
coating a flux on the first solder bump;
heating a substrate including a second solder bump;
pressing the second solder bump onto the stage having asperity;
coating the flux on the second solder bump;
contacting the first solder bump to the second solder bump by disposing the semiconductor component on the substrate; and
coupling the first solder bump and the second solder bump by heating the semiconductor component and the substrate.

2. The method of fabricating the semiconductor device according to claim 1, wherein pressing the first solder bump and the second solder bump on the stage is flattening a height of the first solder bump and a height of the second solder bump.

3. The method of fabricating the semiconductor device according to claim 1, wherein pressing the first solder bump and/or the second solder bump on the stage is performed at a non-oxidizing atmosphere.

4. The method of fabricating the semiconductor device according to claim 1, wherein coating the flux on the first solder bump and/or on the second solder bump is spreading the flux on the stage and transferring the flux to the first solder bump and/or on the second solder bump.

5. The method of fabricating the semiconductor device according to claim 1, wherein temperature of the semiconductor component is larger than the melting point of the first solder bump in heating and temperature of the substrate is larger than the melting point of the first solder bump in heating.

6. A method of fabricating a semiconductor device, comprising:
heating a semiconductor component including a first solder bump;
pressing the first the solder bump onto a stage having asperity;
coating a flux on the first solder bump;
heating a substrate including a second solder bump;
pressing the second solder bump onto the stage having asperity;
coating a resin on the second solder bump;
contacting the first solder bump to the second solder bump by disposing the semiconductor component on the substrate; and
coupling the first solder bump and the second solder bump by heating the semiconductor component and the substrate.

7. The method of fabricating the semiconductor device according to claim 6, wherein pressing the first solder bump and the second solder bump on the stage is flattening a height of the first solder bump and a height of the second solder bump.

8. The method of fabricating the semiconductor device according to claim 6, wherein pressing the first solder bump and/or the second solder bump on the stage is performed at a non-oxidizing atmosphere.

9. The method of fabricating the semiconductor device according to claim 6, wherein coating the flux on the first solder bump is spreading the flux on the stage and transferring the flux to the first solder bump.

10. The method of fabricating the semiconductor device according to claim 6, wherein temperature of the semiconductor component is larger than the melting point of the first solder bump in heating and temperature of the substrate is larger than the melting point of the first solder bump in heating.

11. The method of fabricating the semiconductor device according to claim 6, wherein the second solder bump is buried in the resin in coating the resin on the second solder bump.

12. The method of fabricating the semiconductor device according to claim 6, wherein the resin is a silicone resin.

13. A mounting equipment mounting a semiconductor component including a first solder bump on a substrate including a second solder bump, comprising:
a base;
a semiconductor component supply portion disposed on the base, the semiconductor component supply portion supplying a semiconductor component and a substrate;
a bump pressing portion disposed on the base, the bump pressing portion including a transfer head and a first stage, the bump pressing portion descending the transfer head, the transfer head including a vacuum chuck and a heater, the transfer head retaining the semiconductor component and the substrate, the transfer head moving above the base, the transfer head descending at prescribed portions, the vacuum chuck picking up the semiconductor component and the substrate from the semiconductor component supply portion, the vacuum chuck retaining the semiconductor component and the substrate, the heater heating the semiconductor component and the substrate, the first stage arranged in opposed to the transfer head, the first stage having asperity, the first stage including a vacuum chuck and a heater, the vacuum chuck retaining the substrate, the heater heating the substrate;
the bump pressing portion pressing the semiconductor component and the substrate onto the first stage so as to form a newly exposed surface on the first solder bump and the second solder bump, respectively; and
a semiconductor component disposing portion disposed on the base, the semiconductor component including the second stage, the second stage being disposed the substrate on, wherein the second solder bump on the substrate contact with the first solder bump on the semiconductor component retained by the transfer head.

14. The mounting equipment according to claim 13, further comprising a coating portion disposed on the base, the coating portion coating a flux on the semiconductor component having the first solder bump by transferring and the coating portion coating a resin on the substrate having the second solder bump.

15. The mounting equipment according to claim 13, further comprising a temporary position alignment portion disposed on the base, the temporary position alignment portion being supplied the semiconductor component and the substrate from the semiconductor component supply portion, the temporary position alignment portion aligning a direction between the semiconductor component and the substrate and supplying the semiconductor component and the substrate aligned to the transfer head.

16. The mounting equipment according to claim 13, further comprising the bump pressing portion including a gas nozzle, an outlet end portion of the gas nozzle being arranged near the first stage.

17. The mounting equipment according to claim 13, wherein the asperity of the first stage is a protrusion shape.

18. The mounting equipment according to claim 13, wherein a height of the asperity is 10-20% of a diameter of the first solder bump and/or the second solder bump.

19. The mounting equipment according to claim 13, wherein a width of the asperity is 10-20% of a diameter of the first solder bump and/or the second solder bump.

20. The mounting equipment according to claim 13, wherein the semiconductor component supply portion is constituted with the semiconductor component supply portion supplied the semiconductor component and the substrate supply portion supplied the substrate.
